(19) United States
(12) Patent Application Publication
(10) Pub. No.: US 2026/0238884 A1
(43) Pub. Date: Aug. 13, 2026

(54) METHOD AND DEVICE FOR CONTROLLING AUTO FOCUS FRAME BY FRAME

(71) Applicant: HANWHA VISION CO., LTD., Seongnam-si (KR)

(72) Inventor: Taeyoung OH, Seongnam-si (KR)

(73) Assignee: HANWHA VISION CO., LTD., Seongnam-si (KR)

(21) Appl. No.: 19/095,764

(22) Filed: Mar. 31, 2025

(30) Foreign Application Priority Data
Feb. 13, 2025 (KR) 10-2025-0018484

(51) Int. Cl. H04N 23/67; H04N 23/60

(52) U.S. Cl. CPC H04N 23/67; H04N 23/665

(57) ABSTRACT

A device and method for controlling frame-based auto-focus are provided. An interrupt received through a hardware controller is managed without a central processing unit (CPU) intervention, and motor reading and motor writing are performed in parallel and simultaneously upon receiving a first interrupt. Once motor writing is completed, at least one AF setting value is calculated based on the second interrupt.

### CROSS-REFERENCE TO RELATED APPLICATION

This application claims priority under 35 U.S.C.§119 to Korean Patent Application No.10-2025-0018484, filed on February 13, 2025, in the Korean Intellectual Property Office, the disclosure of which is herein incorporated by reference in its entirety.

### BACKGROUND

### Field

One or more embodiments of the present disclosure relate to an auto-focus control method and an auto-focus control device that maintain stable image quality in camera systems through frame-based auto-focus control (AF), even under rapidly changing scenes.

More specifically, one or more embodiments of the present disclosure relate to a technology for managing interrupts using a hardware controller without central processing unit (CPU) intervention, ensuring frame-based focus setting times and preventing image quality degradation.

### Description of Related Art

Related art camera auto-focus systems rely on a central processing unit (CPU) to perform all calculations related to focus control, including interrupt handling and motor control. This approach may cause issues in guaranteeing the precise calculation time and motor movement time required for focus setting. In particular, under rapidly changing scenes or moving objects, delays in frame-based focus setting often lead to image quality degradation.

Existing technologies primarily use CPUs based on Linux or real-time operating systems (RTOS), but these systems face difficulties in immediately controlling a motor in response to Vsync signals, resulting in delays of one or two frames or more. Consequently, frequent issues arise in video quality due to improper focus during quick scene transitions.

### SUMMARY

To solve the aforementioned problems, one or more embodiments of the present disclosure provide a frame-based auto-focus control method and a frame-based auto-focus control device that manage interrupts using a hardware controller without central processing unit (CPU) intervention and perform motor reading (Motor Read) and motor writing (Motor Write) in parallel, thereby enabling stable frame-by-frame focus setting.

Additionally, one or more embodiments of the present disclosure may guarantee an accuracy of frame-by-frame focus setting time and implement a system capable of preventing image quality degradation even under rapidly changing scenes.

Objects of the present disclosure are not limited to the aforementioned objects, and other objects not mentioned may be clearly understood by those skilled in the art from the detailed description of the present disclosure.

In one aspect of an example embodiment of the present disclosure, provided is a frame-based auto-focus control device including: an auto-focus motor; a hardware controller configured to manage a received interrupt; and a processor configured to: perform motor reading to obtain to obtain a position and a speed of the auto-focus motor for a first period in response to a first interrupt, perform motor writing to control a movement of the auto-focus motor based on an auto-focus (AF) calculation result from a previous frame, and calculate at least one AF setting value to be used in a next frame for a second period based on a second interrupt received after the motor writing is completed.

The processor may independently control the motor reading and the motor writing to be performed substantially simultaneously based on the first interrupt.

The first interrupt may include a vertical synchronization (Vsync) signal of an image sensor, and the second interrupt may include a general-purpose input/output (GPIO) trigger signal.

The hardware controller may include: a first hardware controller configured to detect the Vsync signal or the GPIO trigger signal and transmit a motor reading command and a motor writing command via a Serial Peripheral Interface (SPI) bus; and a second hardware controller configured to receive the motor reading command and the motor writing command via the SPI bus and trigger the motor reading and the motor writing.

The second hardware controller may include an SPI controller, and the SPI controller may control the motor reading and the motor writing to be performed in parallel via the SPI bus.

The processor may control the motor reading, motor writing, and the calculation of the at least one AF setting value to be performed within a time obtained by summing the first period and the second period for each frame.

The processor may detect a blank section while capturing frame data through the image sensor and control the motor reading and the motor writing to be performed during the blank section.

The processor may include a hardware accelerator or a neuromorphic computing device configured to calculate the at least one AF setting value.

The processor may predict a focus position in a current frame based on a motion prediction algorithm using deep learning-based motion estimation along with the AF calculation result from the previous frame and control the motor writing to be performed based on the predicted result.

The processor may correct a focus state by receiving a feedback through a closed-loop control method during the motor writing after motor reading.

In one aspect of an example embodiment of the present disclosure, provided is a frame-based auto-focus control method, including: receiving a first interrupt; performing motor reading and motor writing for a first period in response to the first interrupt; receiving a second interrupt after motor writing is completed; and calculating at least one AF setting value for a next frame for a second period based on the second interrupt.

The method may independently control the motor reading and the motor writing to be performed substantially simultaneously based on the first interrupt.

The first interrupt may include a Vsync signal of the image sensor, and the second interrupt may include a GPIO trigger signal.

The receiving the first interrupt may include: detecting the Vsync signal or GPIO trigger signal with a first hardware controller and transmitting a motor reading command and a motor writing command via an SPI bus; and receiving the motor reading and the motor writing commands via the SPI bus with a second hardware controller and triggering the motor reading and the motor writing.

The second hardware controller may include an SPI controller, and the method may control the SPI controller to perform the motor reading and the motor writing in parallel via the SPI bus.

The method may control the motor reading, motor writing, and the calculation of the at least one AF setting value to be performed within a time obtained by summing the first period and the second period for each frame.

The performing motor reading and the motor writing may include detecting a blank section while capturing frame data through the image sensor and controlling the motor reading and the motor writing to be performed during the blank section.

In an aspect of an example embodiment of the present disclosure, provided is a frame-based auto-focus control device including: a memory storing at least one program; a hardware controller configured to manage a received interrupt; and a processor executing the at least one program, wherein the at least one program includes: a first instruction to perform motor reading and motor writing in parallel when a first interrupt is detected through the hardware controller; and a second instruction to calculate at least one AF setting value for a next frame when a second interrupt is detected through the hardware controller after motor writing is completed.

The first instruction may be performed for a first period, and the second instruction may be performed for a second period, and the first instruction and the second instruction may be performed within a time obtained by summing the first period and the second period for each frame.

The first interrupt may include a Vsync signal of the image sensor, and the second interrupt may include a GPIO trigger signal.

### BRIEF DESCRIPTION OF DRAWINGS

The accompanying drawings, which are included to provide a further understanding of the present disclosure and constitute a part of the detailed description, illustrate example embodiments of the present disclosure and serve to explain technical features of the present disclosure together with the description.

FIG. 1 is a schematic diagram illustrating a surveillance camera system according to an embodiment of the present disclosure.

FIG. 2 is a schematic block diagram of an image processing device according to an embodiment.

FIG. 3 is a diagram illustrating a configuration in which a hardware controller directly manages interrupts in an image processing device according to an embodiment of the present disclosure.

FIG. 4 is a diagram illustrating a sequence for controlling an auto-focus motor according to an embodiment of the present disclosure.

FIGS. 5 to 6 are flowcharts of a frame-based auto-focus control method according to an embodiment of the present disclosure.

FIG. 7 is a diagram illustrating a block-level operation of a device for controlling an auto-focus motor according to an embodiment of the present disclosure.

The accompanying drawings, which are included as part of the detailed description to aid understanding of the present disclosure, provide embodiments of the present disclosure and together with the detailed description explain technical features of the present disclosure.

### DETAILED DESCRIPTION

Hereinafter, one or more example embodiments disclosed in the present disclosure will be described in detail with reference to the accompanying drawings. Identical or similar components are assigned the same reference numerals, regardless of their depiction in the drawings, and redundant descriptions will be omitted. The suffixes “module” and “unit” used for components in the following description are provided solely for the convenience of writing this specification and do not indicate any distinct meanings or functions by themselves.

Moreover, detailed descriptions of well-known techniques will be omitted when it is determined that they could obscure the gist of the embodiments disclosed herein. The attached drawings are provided to aid in the understanding of the disclosed embodiments and do not limit the technical ideas disclosed herein. The technical scope of the present disclosure should be interpreted as including all modifications, equivalents, and substitutions within the spirit of the present disclosure.

Terms including ordinals such as “first” and “second” may be used to describe various components, but the components should not be limited by these terms. These terms are used only to distinguish one component from another.

When an element is referred to as being “connected to” or “coupled to” another element, it may be directly connected or coupled to the other element, or intervening elements may be present. In contrast, when an element is referred to as being “directly connected to” or “directly coupled to” another element, there are no intervening elements.

Unless otherwise clearly indicated by the context, the singular forms used herein include plural forms as well.

In the embodiments of the present disclosure, terms such as “comprises” or “includes” specify the presence of features, numbers, steps, operations, components, parts, or combinations thereof described in the specification, and do not preclude the presence or addition of one or more other features, numbers, steps, operations, components, parts, or combinations thereof.

Moreover, in the embodiments of the present disclosure, “at least one” among a plurality of components may refer to any combination, including all components, any individual component, or any subset of components.

The phrase “configured to” may, depending on the context, be used interchangeably with phrases such as “suitable for,” “having the capacity to,” “designed to,” “adapted to,” “made to,” or “capable of.” The phrase “configured to” does not necessarily mean a component specifically designed in hardware. For example, the phrase “a processor configured to perform A, B, and C” may include a dedicated processor designed to execute such tasks (e.g., an embedded processor) or a general-purpose processor (e.g., a central processing unit (CPU) or application processor) capable of performing such tasks through the execution of one or more software programs stored in a memory device.

In this specification, the term “image” may encompass various forms, including a video, a still image, and a non-continuous video format such as Motion Joint Photographic Experts Group (MJPEG).

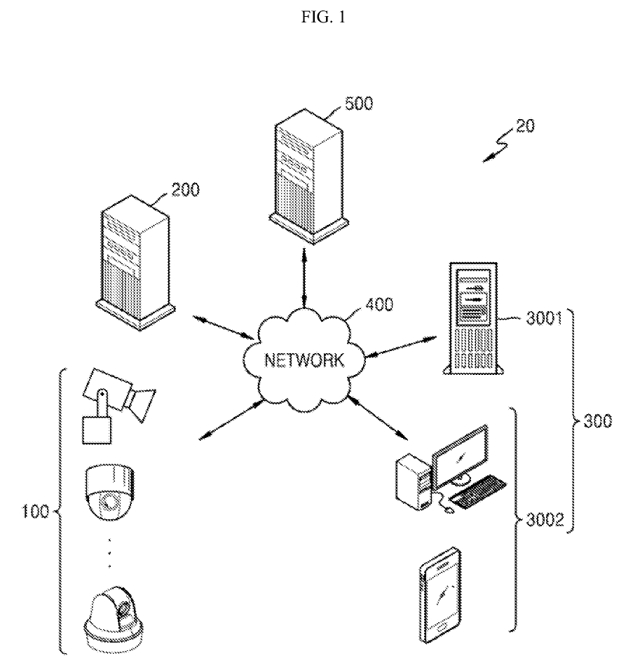

FIG. 1 is a schematic diagram illustrating a surveillance camera system according to an embodiment.

Referring to FIG. 1, a surveillance camera system 20 according to an embodiment may include an image processing device 100 and an external device 300. In an embodiment, the surveillance camera system 20 may further include a network server 200 capable of wired or wireless communication with the image processing device 100 and the external device 300.

The image processing device 100 may be an electronic device for capturing a monitored area and obtaining a video and an audio from the monitored area. The image processing device 100 may capture the monitored area in real time for surveillance or security purposes and may include one or more components. The image processing device 100 may include a fixed-position camera installed at a specific location, a camera that may move automatically or manually along a set path, and/or a camera that may be moved by a person or robot. The image processing device 100 may include a PTZ (Pan-Tilt-Zoom) camera with pan, tilt, and zoom functions. The image processing device 100 may be an analog camera or an Internet protocol (IP) or network camera connected via wired or wireless internet. Depending on the camera’s functionality and purpose, the image processing device 100 may take various forms and sizes, such as dome-shaped, box-shaped, bullet-shaped, or camouflaged types.

In an embodiment, the image processing device 100 may be a visible light camera that acquires image information by detecting light and generates a visible image based on the luminance distribution of objects. In another embodiment, the image processing device 100 may be an infrared camera (or thermal imaging camera) that detects thermal energy emitted by objects as infrared wavelengths, a type of an electromagnetic wave. The image processing device 100 may measure an intensity of thermal energy and generate a thermal image where different colors represent varying intensities.

The image processing device 100 may have functions to record a video or capture an image of the monitored area. The image processing device 100 may also have functions to record a sound occurring in the monitored area. The image processing device 100 may generate alerts and/or initiate recording and/or capture an image when a change, such as a movement or a sound, is detected in the monitored area.

The image processing device 100 may analyze the captured video itself or the video obtained after editing. For example, the image processing device 100it may use an object detection algorithm to detect an object within the video. The object detection algorithm may apply artificial intelligence (AI)-based techniques, using a pre-trained artificial neural network model(s) to detect an object.

The image processing device 100 may analyze the video and generate metadata along with index information for the metadata. The image processing device 100 may analyze an audio included in the video, either jointly or separately, to generate metadata and corresponding index information.

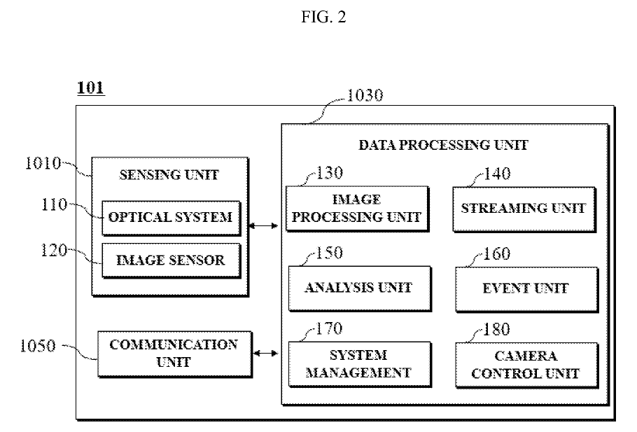

The network server 200 may provide various functionalities to the image processing device 100 and the external device 300 through the network 400. In FIG. 2, the network server 200 is depicted as a standalone component separate from the image processing device 100, but the embodiments of the present disclosure are not limited to this configuration. For example, the network server 200 may be embedded within the image processing device 100. A detailed description of the network server 200 will be provided later.

The external device 300 may include a server 3001 and a client 3002.

The server 3001 may include devices such as a Digital Video Recorder (DVR), a Network Video Recorder (NVR), or a Video Management System (VMS) and provide functions such as video storage, retrieval, and/or management. The server 3001 may receive a video and/or an audio from the image processing device 100, store the video and/or the audio, and index the video and/or the audio for user searches. The server 3001 may also analyze the video and/or the audio received from the image processing device 100. In an embodiment, multiple servers 3001, which are physically located in different places, may be federated and managed under a single software system.

The client 3002 may be a terminal that includes devices such as a desktop PC, a tablet PC, a slate PC, a notebook computer, or a mobile device such as a smartphone. The client 3002 may have software and/or applications installed for video monitoring and retrieval by a user (operator). In an embodiment, the client 3002 may be installed, for example, in public institutions, police stations, hospitals, central control rooms, central monitoring centers, or comprehensive situation rooms. The client 3002 may be connected to the image processing device 100 and/or the server 3001 through a network. In an embodiment, the client 3002 may manage and operate the image processing device 100 and the server 3001 based on a cloud system.

In an embodiment, the client 3002 may send a data provision request signal to the image processing device 100 or the server 3001, requesting the provision of all or part of the video and/or the audio. The client 3002 may then receive all or part of the video and/or the audio from the image processing device 100 or the server 3001. The client 3002 may also send a data provision request signal to the image processing device 100 or the server 3001, requesting metadata and/or index information obtained by analyzing the video and/or the audio, and may receive the requested metadata and/or index information.

The image processing device 100, the network server 200, and the external device 300 may communicate via wired or wireless communication through the network 400. The network 400 may include wired networks such as Local Area Networks (LANs), Wide Area Networks (WANs), Metropolitan Area Networks (MANs), and Integrated Service Digital Networks (ISDNs). The network 400 may also include wireless internet networks such as 3G, 4G (LTE), 5G, WiFi, Wireless Broadband (WiBro), WiMAX, wireless LANs, and code division multiple access (CDMA). Additionally, the network 400 may include wireless communication technologies such as satellite communication, Bluetooth, Radio Frequency Identification (RFID), Infrared Data Association (IrDA), Ultra Wideband (UWB), ZigBee, and Near Field Communication (NFC). In the case of wireless mobile communication, the network 400 may further include components such as a Base Transceiver Station (BTS), a Mobile Switching Center (MSC), a Home Location Register (HLR), an Access Gateway for transmitting and receiving wireless packet data, and a Packet Data Serving Node (PDSN). The scope of the present disclosure is not limited to these configurations.

The video analysis server 500 may be a device that receives and stores the video itself, which is captured through the image processing device 100, and/or the video obtained through editing. The video analysis server 500 may perform the video and/or audio analysis functions of the image processing device 100. For example, the video analysis server 500 may analyze video and/or the audio received in real time from the image processing device 100 or analyze stored video according to its intended use. The video analysis server 500 may analyze the video to generate metadata and corresponding index information. The video analysis server 500 may also analyze audio contained in the video either jointly or separately to generate metadata and corresponding index information. The video analysis server 500 may be an AI server implementing artificial intelligence-based video analysis functions.

The external device 300 may send a data provision request signal to the video analysis server 500 to request provision of all or part of the video and/or the audio. The external device 300 may also send a request signal to the video analysis server 500 for metadata and/or index information obtained by analyzing the video and/or the audio.

FIG. 2 shows schematic block diagrams of the image processing device according to an embodiment.

In an embodiment, the image processing device 100 may include a camera 101. The camera 101 may be an IP camera or a network camera. The camera 101 may capture images, compress the captured images, and transmit the compressed images to an external device 300 (refer to FIG. 2) using a predetermined transmission protocol. For example, the camera 101 may capture images, analyze the captured images in real time to detect, identify, track, analyze a behavior of, and search for a target and/or a moving object, and provide appropriate information or functions to the user.

The camera 101 may include a sensing unit 1010, a data processing unit 1030, and a communication unit 1050.

The sensing unit 1010 may be a detection means that includes an optical system 110 and an image sensor 120.

The optical system 110 may optically process light from a subject. The optical system 110 may include at least one lens, such as a zoom lens for controlling a field of view according to a focal length and a focus lens for focusing. In an embodiment, the lens may include at least one glass lens and/or at least one liquid lens. The liquid lens may adjust its shape (curvature) using a fluid to control zoom and focus. The liquid lens may have advantages such as reducing a number and a size of lenses and quickly achieving a desired focal length.

The optical system 110 may further include an optical low-pass filter (OLPF), an infrared cut filter (IRCF), and/or an iris for controlling light intensity.

The image sensor 120 may capture images of the monitored area. In an embodiment, the image sensor 120 may be implemented using a Charge-Coupled Device (CCD) sensor or a Complementary Metal-Oxide-Semiconductor (CMOS) sensor. The image sensor 120 may convert optical signals transmitted through the optical system 110 into electrical signals.

The data processing unit 1030 may be an information processing means implemented with various hardware and/or software configurations to execute specific functions. For example, the data processing unit 1030 may represent a hardware-embedded data processing device structured to execute functions expressed in the form of codes or commands included in a program. The hardware-embedded data processing device may encompass devices such as a microprocessor, a central processing unit (CPU), an image signal processor (ISP), a processor core, a multiprocessor, an application-specific integrated circuit (ASIC), a field-programmable gate array (FPGA), and others, but the scope of the present disclosure is not limited thereto.

In an embodiment, the data processing unit 1030 may include a neural processing unit (NPU). The NPU may be integrated into the aforementioned processing unit or processor. The NPU may be a processor specialized for processing an artificial intelligence model(s), which may be created through machine learning. The AI model may include multiple layers of artificial neural networks, such as deep neural networks (DNNs), convolutional neural networks (CNNs), recurrent neural networks (RNNs), restricted Boltzmann machines (RBMs), deep belief networks (DBNs), and others.

The AI model may be trained by collecting and labeling appropriate training data for tasks such as object detection, classification, and/or recognition. The trained AI model may be embedded in the camera 101 and used for inference operations, including object detection, classification, and/or recognition, through the neural processing unit or the aforementioned data processing devices.

In an embodiment, after the AI model is deployed in the camera 101, the AI model may undergo additional training via a cloud server to adapt to a monitoring environment and/or user requirements. The newly trained model may be redistributed to the camera 101.

The image processing unit 130 may improve image quality by adjusting parameters such as brightness, contrast, color, and/or sharpness. The image processing unit 130 may perform image signal processing for noise reduction, gamma correction, color correction, and/or edge enhancement.

The streaming unit 140 may compress the video received from the image processing unit 130 and provide the compressed video to external devices through the network.

The analysis unit 150 may analyze the video processed by the image processing unit 130 in real time. The analysis unit 150 may perform background detection, foreground and object detection, object counting, camera tampering detection, and/or face detection.

The analysis unit 150 may detect motion using motion detection algorithms and distinguish between vocal and non-vocal audios using an artificial neural network(s).

The event unit 160 may receive metadata from the analysis unit 150 and detect events based on the metadata. The event unit 160 may trigger an action, such as an alarm, when a specific event occurs.

The system management unit 170 may manage firmware updates and product information, as well as provide power to various components of the camera.

The camera control unit 180 may control the camera’s position and orientation based on motion information, user inputs, or preset configurations.

The communication unit 1050 may be an interface that enables wired or wireless communication with the network server 200 and the external device(s) 300. The communication unit 1050 may transmit streams using protocols such as TCP/IP, HTTPS, RTP/RTSP, FTP, and MQTT.

Only components related to the present embodiment are depicted to prevent the features of the present embodiment from being obscured. Therefore, it will be understood by those skilled in the relevant technical field that additional general-purpose components may be included beyond those shown in FIG. 2.

According to an embodiment of the present disclosure, the frame-based auto-focus control device may include a focus control unit (not shown). The focus control unit may adjust the camera’s focus using a focus control algorithm. In an embodiment, the focus control unit may control a focus motor based on a control signal for focus control to move a position of the focus lens. The focus control algorithm may include known an auto-focus algorithm(s), such as a hill-climbing method.

For example, the focus control unit may continuously move the focus lens between a near point and a far point (e.g., infinity) in real time, comparing focus values before and after the movement. The focus control unit may determine a change in the focus value, a slope, and/or a variation in the slope to identify a peak point with a highest focus value as an in-focus position. The focus motor may then be controlled to move the focus lens to the in-focus position.

In an embodiment, the focus control unit may control a curvature of a liquid lens based on the control signal for focus control to achieve proper focus.

With respect to the aforementioned focus control algorithm, the frame-based auto-focus control device according to an embodiment of the present disclosure may ensure a temporal accuracy of motor control by employing a dedicated hardware device to directly manage an interrupt(s).

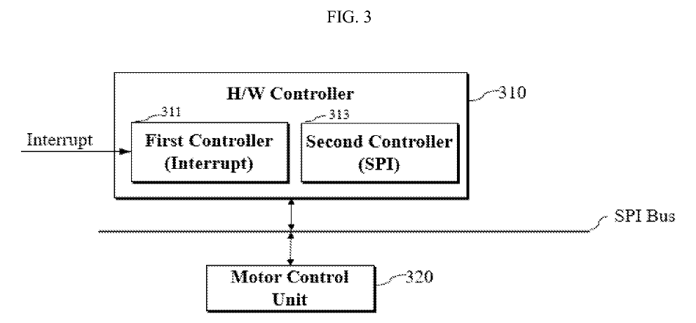

FIG. 3 illustrates a configuration in which a hardware controller directly manages interrupts in an image processing device according to an embodiment of the present disclosure.

Referring to FIG. 3, a first hardware controller 311 may detect and immediately process an external interrupt, such as Vsync signals and Trigger by GPIO signals. Upon detecting an interrupt, the first hardware controller 311 may transmit a command(s) to the second hardware controller 312 to control motor reading (Motor Read) and motor writing (Motor Write). This may ensure that motor control is precisely executed at an occurrence of the Vsync signal, thereby controlling temporal irregularities.

A second hardware controller 313 may exchange data with a motor control unit 320 at high speed via a Serial Peripheral Interface (SPI) bus and reflect real-time information such as the motor’s current position and speed. Based on the commands received from the first hardware controller 311, the second hardware controller 313 may deliver a motor movement position and a setting to the motor control unit 320 to ensure that the lens moves accurately to a target position.

The motor control unit 320 drives an auto-focus control (AF) motor to move the focus lens according to the command(s) received from the second hardware controller 313. Additionally, the motor control unit 320 may provide feedback data, such as the motor’s current position and speed, to the second hardware controller 313 such that the system may continuously correct a focus state in real time.

The SPI bus may serve as a data transmission path between the second hardware controller 313 and the motor control unit 320, ensuring that motor reading and motor writing are performed in parallel. The SPI (Serial Peripheral Interface) bus, which is a high-speed serial data communication protocol, supports full-duplex communication, allowing simultaneous data transmission and reception. This design may enable motor reading data to be received while motor writing commands are being transmitted, ensuring parallel execution without delays.

Accordingly, as described in the present disclosure, motor reading data may be received concurrently with transmission of motor writing commands, allowing command transmission and status feedback to occur simultaneously without a time delay.

Furthermore, the second hardware controller 313 may independently manage data channels for motor reading and motor writing, enabling parallel processing. The SPI bus may be directly managed by the hardware controller 310, allowing commands to be processed quickly without CPU intervention. As a result, at least one AF setting value may be applied without delay, ensuring accurate focus even during rapid scene transitions and preventing image quality degradation.

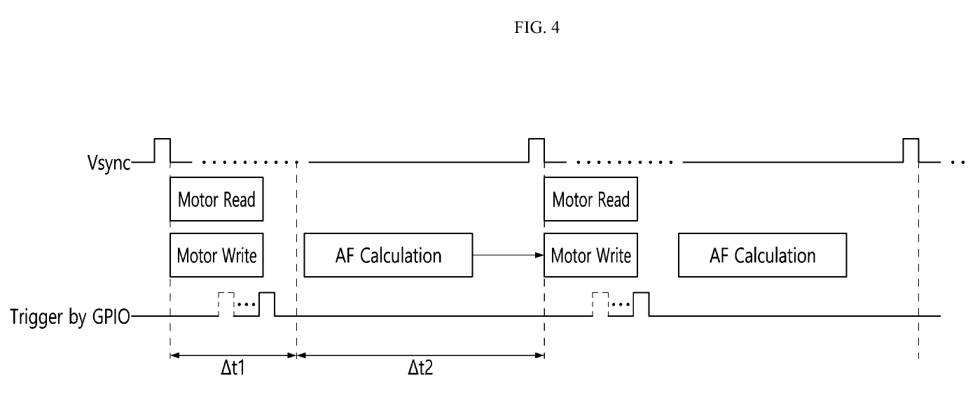

FIG. 4 illustrates the sequence for controlling an auto-focus motor according to an embodiment of the present disclosure. The auto-focus motor control method described in this embodiment may be implemented through the processor (or data processing unit) 1030 shown in FIG. 1.

Referring to FIG. 4, when a Vsync signal is generated, motor reading (Motor Read) and motor writing (Motor Write) may be performed sequentially and in parallel during a △t1 period, and AF calculation (AF Calculation) may be performed during a △t2 period.

A total time (T) is represented as T = △t1 + △t2, where: △t1 is a period during which motor control operations (e.g., motor reading and motor writing) are performed. △t2 is a period during which the AF calculation is performed.

When a first interrupt (Vsync signal) is detected from the image sensor, a new frame may be initiated. Upon an occurrence of the first interrupt, the hardware controller may immediately detect the first interrupt and initiate the motor reading operation. During the first time period (△t1), motor reading may retrieve data such as the current position and speed of the focus lens. The processor (or data processing unit 1030 in FIG. 1) may retrieve motor status information from the motor control unit 320 shown in FIG. 3.

During the first time period △t1, one or more commands are issued based on the AF calculation result from a previous frame to move the lens to the target position (Motor Write). Because motor reading and motor writing are performed in parallel via the SPI bus, motor configuration may be completed within the first time period (△t1).

When motor writing is completed and a second interrupt (GPIO trigger signal) occurs, the second interrupt triggers the AF calculation. During the second time period (△t2), at least one AF setting value to be used in a next frame may be calculated based on data collected in a current frame. The second time period (△t2) may be separate from the first time period (△t1), ensuring sufficient time for calculations and accurate application of the setting values before a start of the next frame.

Once the AF calculation is completed, a new first interrupt (Vsync) may be generated, allowing motor reading and motor writing to resume for the next frame.

The motor reading, motor writing, and AF calculation may be controlled to be performed within a time obtained by summing the first and second time periods for each frame.

In an embodiment of the present disclosure, motor writing during the current frame may be based on the AF calculation result from the previous frame. However, in cases of sudden scene changes or rapid object movement within the current frame, applying the previous frame’s AF calculation result may lead to image degradation or incorrect focus. To address this, a hardware accelerator and/or a neuromorphic computing device for AF calculation may be used to minimize image degradation.

Additionally, the processor may predict the focus position in the current frame using a motion prediction algorithm based on deep learning-based motion estimation combined with the AF calculation result from the previous frame. Motor writing may then be controlled based on the predicted result, further minimizing image degradation.

Moreover, in an embodiment, the processor may perform feedback-based correction of the focus state through a closed-loop control method while performing motor writing after motor reading. This allows more accurate focus adjustment within the current frame.

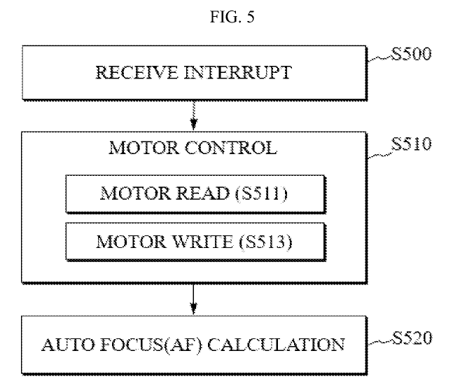

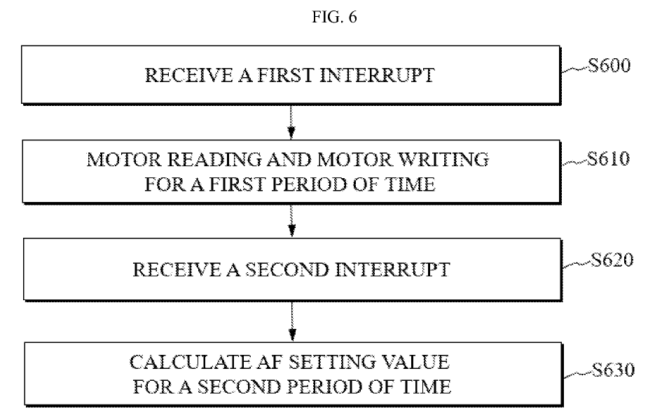

FIGS. 5 to 6 illustrate the flowchart of the frame-based auto-focus control method according to an embodiment of the present disclosure. As described earlier, the control method disclosed in FIGS. 5 to 6 may be implemented by the processor (data processing unit 1030) of FIG. 1.

The processor may receive an interrupt (S500). The processor may detect a Vsync signal or GPIO trigger signal through the hardware controller (referring to FIG. 3) and initiate the AF motor control operation. The hardware controller may directly manage the interrupts, enabling rapid and accurate processing to trigger a next motor control step. (S510)

The processor may obtain the current motor position, speed, and configuration values (S511, Motor Reading). Simultaneously, the processor may perform the motor writing operation (S513). Based on the at least one AF setting value calculated in the previous frame, the processor may control the motor to move the focus lens to the target position. Motor control may be performed in parallel through the SPI bus, minimizing a time delay.

The processor may calculate the at least one AF setting value to be used in the current frame based on the data obtained during the motor reading step (S520). The at least one AF setting value may be used to control the motor in the next frame, with sufficient computation time ensured to prevent frame interference.

Referring to FIG. 6, when the processor may receive the first interrupt (e.g., Vsync signal) (S600), motor control may begin during the first time period (△t1). During the first time period (△t1), the processor may perform motor reading and motor writing (S610). As described earlier, motor control may be performed in parallel through the SPI bus, ensuring that the configuration is completed within the △t1 period.

Once motor writing is completed, a GPIO trigger signal may be generated through a trigger signal generator (not shown). The processor may then receive the second interrupt (GPIO trigger signal) (S620) and calculate the at least one AF setting value during the second time period (△t2) (S630). The optimal AF setting value(s) for the next frame may be calculated based on the data collected in the current frame.

As described, the time periods △t1 and △t2 may be clearly separated, allowing each step to be performed efficiently and sequentially. This separation may ensure temporal consistency, which plays a crucial role in preventing image quality degradation.

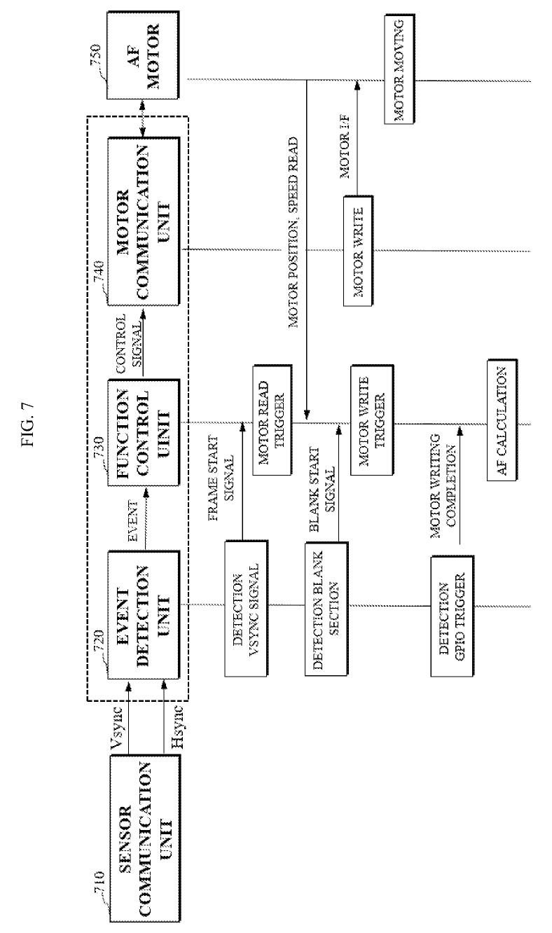

FIG. 7 illustrates the block-level operation of a device for controlling an auto-focus motor according to an embodiment of the present disclosure. Each block may operate cooperatively based on Vsync signals and GPIO trigger signals, and the hardware controller may quickly transfer data between blocks via the SPI bus, ensuring system-wide synchronization. This allows accurate frame-based AF settings and stable focus maintenance even during rapid scene transitions.

Referring to FIG. 7, a sensor communication unit 710 may generate vertical synchronization signals (Vsync) and horizontal synchronization signals (Hsync) from the image sensor and deliver these signals to an event detection unit 720. The sensor communication unit 710 may also receive image data and reflect the motor state in real time according to the at least one AF setting value.

The event detection unit 720 nay detect Vsync and Hsync signals to recognize a frame start point and a blank section. When a Vsync signal is detected, the event detection unit 720 may send a frame start signal to a function control unit 730 to trigger motor reading. The blank section refers to a period when the image sensor does not output data during frame switching. By accurately detecting this blank section, motor reading and motor writing may be performed within the blank section, preventing interference with the image sensor’s data capture. Performing motor control during the blank section allows the application of accurate settings within the current frame while minimizing inter-frame delays. Since the blank section represents a period when hardware resources are relatively idle, focusing motor control and computations during this period may optimize an overall system performance.

When the blank section is detected, the function control unit 730 may control motor reading and motor writing during this period. The function control unit 730 may trigger motor reading based on the frame start signal from the event detection unit 720 and ensure that motor reading and writing are completed within the blank section. All control signals may be transmitted to motor communication unit 740 to ensure accurate motor operations.

A motor communication unit 740 may execute motor reading and motor writing based on commands received from the function control unit 730. The motor communication unit 740 may communicate with an AF motor 750 via the SPI bus to retrieve the motor’s current position and speed information and transmit related motor setting values to move the focus lens. An actual motor status (e.g., position, speed, etc.) may be fed back to the function control unit 730 to be reflected in the focus setting of the next frame.

The AF motor 750 may move the focus lens based on the received setting values.

The frame start signal may be generated when the Vsync signal from the sensor communication unit 710 is detected by the event detection unit 720 and delivered to the function control unit 730. The function control unit 730 may trigger motor reading through the motor communication unit 740 to retrieve the current motor position and speed information.

When the blank section is detected by the event detection unit 720, motor writing may be triggered. The function control unit 730 may send optimal focus setting values for the current frame to the motor communication unit 740 based on the at least one AF setting value calculated in the previous frame. The motor communication unit 740 may transmit the setting values to the AF motor 750 to move the focus lens to the target position.

Once motor writing is completed and the GPIO trigger signal is detected, the AF calculation may be triggered. Using data from the current frame, the at least one AF setting value for the next frame may be calculated.

As the AF motor moves to the set position, the motor communication unit 740 may feed back the current motor status (position, speed, etc.) to the system, allowing real-time monitoring and correction of the focus state.

According to an embodiment of the present disclosure, interrupts may be directly managed through the hardware controller, which may reduce a CPU load and allow AF calculations to be performed efficiently without being limited by CPU performance constraints.

Additionally, according to an embodiment of the present disclosure, motor reading and motor writing may be processed in parallel, minimizing delays in focus setting between frames.

Furthermore, according to an embodiment of the present disclosure, motor control and computations may be performed during the blank section, preventing interference with the active frame section and maintaining stable image quality.

Effects of the present disclosure are not limited to the aforementioned effects, and other effects not mentioned may be clearly understood by those skilled in the art from the description below.

The present disclosure may be applied to various devices and fields, including surveillance cameras, autonomous vehicles, user terminals, and servers. The present disclosure may be integrated with artificial intelligence (AI) modules, robotics, augmented reality (AR) devices, virtual reality (VR) devices, and 5G service-related equipment.

The present disclosure may be integrated with one or more of the surveillance cameras, autonomous vehicles, user terminals, and servers. The present disclosure may connect to artificial intelligence (AI) modules, robots, augmented reality (AR) devices, virtual reality (VR) devices, and devices related to 5G services, thereby expanding its application to various smart environments and security systems.

For better understanding of the present disclosure, reference numerals have been provided in the preferred embodiments depicted in the drawings, and specific terms have been used to describe the embodiments. However, the present disclosure is not limited by these specific terms and includes all components that may be commonly considered by those skilled in the art.

The present disclosure may be represented by functional block configurations and various processing steps. These functional blocks may be implemented using various hardware and/or software configurations capable of executing specific functions. For example, the present disclosure may employ direct circuit configurations such as memory, processing units, logic, and lookup tables, which execute various functions under the control of one or more microprocessors or other control devices. Similarly, components of the present disclosure may be implemented using programming or scripting languages such as C, C++, Java, and assembler, which may represent algorithms, data structures, processes, routines, or other programming constructs.

The functional aspects of the present disclosure may be implemented as algorithms executed by one or more processors. Additionally, related art technologies may be utilized for electronic configuration, signal processing, and/or data processing. Terms such as “mechanism,” “element,” “means,” and “configuration” are used broadly and are not limited to mechanical or physical constructs. These terms may include a set of software routines associated with a processor.

The specific implementations described herein are merely examples and do not limit the scope of the present disclosure. For conciseness, descriptions of related art electronic components, control systems, software, and other functional aspects of such systems may be omitted. The connections or connecting elements shown in the drawings represent functional and/or physical or circuit connections, which may vary or include additional connections in actual implementations.

Unless explicitly stated as “essential” or “critical,” the components mentioned in the present disclosure may not be strictly necessary for the application of the disclosure. The use of terms such as “the” or similar directive terms in the specification (particularly in the claims) may refer to both singular and plural forms. Where a range is described, it includes individual values within the range, and the disclosure encompasses applications using those individual values, as if each were explicitly stated.

Lastly, unless explicitly stated otherwise or indicated by the order of description, the steps constituting the method of the present disclosure may be performed in any suitable order. The disclosure is not necessarily limited to the sequential order of steps as described.

Although embodiments of the present invention disclosure have been described in detail hereinabove, the scope of the present invention disclosure is not limited thereto, but may include several modifications and alterations made by those skilled in the art using a basic concept of the present invention disclosure as defined in the claims and their equivalents.

What is claimed is:

1. A frame-based auto-focus control device comprising:
an auto-focus motor;
a hardware controller configured to manage a received interrupt; and
a processor configured to:
perform motor reading to obtain a position and a speed of the auto-focus motor for a first period of time, in response to receiving a first interrupt;
perform motor writing to control a movement of the auto-focus motor, based on an auto-focus (AF) calculation result calculated from a previous frame; and
calculate at least one AF setting value to be used in a next frame for a second period of time, based on a second interrupt received after the motor writing is completed.

2. The frame-based auto-focus control device according to claim 1, wherein the processor is configured to independently control the motor reading and the motor writing to be performed substantially simultaneously based on the first interrupt.

3. The frame-based auto-focus control device according to claim 1, wherein the first interrupt includes a vertical synchronization (Vsync) signal of an image sensor, and the second interrupt includes a general-purpose input/output (GPIO) trigger signal.

4. The frame-based auto-focus control device according to claim 3, wherein the hardware controller comprises:
a first hardware controller configured to detect the Vsync signal or the GPIO trigger signal and transmit a motor reading command and a motor writing command via a Serial Peripheral Interface (SPI) bus; and
a second hardware controller configured to receive the motor reading command and the motor writing command from the first hardware controller via the SPI bus and trigger the motor reading and the motor writing.

5. The frame-based auto-focus control device according to claim 4, wherein the second hardware controller includes an SPI controller, and the SPI controller is configured to perform the motor reading and the motor writing in parallel via the SPI bus.

6. The frame-based auto-focus control device according to claim 1, wherein the processor is configured to control the motor reading, the motor writing, and the calculation of the at least one AF setting value to be performed within a time obtained by summing the first period of time and the second period of time for each frame.

7. The frame-based auto-focus control device according to claim 1, wherein the processor is configured to detect a blank section while capturing frame data through an image sensor and control the motor reading and the motor writing to be performed during the blank section.

8. The frame-based auto-focus control device according to claim 1, wherein the processor includes a hardware accelerator or a neuromorphic computing device configured to calculate the at least one AF setting value.

9. The frame-based auto-focus control device according to claim 1, wherein the processor is configured to predict a focus position in a current frame based on a motion prediction algorithm using deep learning-based motion estimation along with the AF calculation result from the previous frame, and control the motor writing to be performed based on the predicted result.

10. The frame-based auto-focus control device according to claim 1, wherein the processor is configured to receive a feedback on a focus state through a closed-loop control method and perform correction while performing the motor writing after the motor reading.

11. A frame-based auto-focus control method comprising:
receiving a first interrupt;
performing motor reading and motor writing for a first period of time in response to the first interrupt;
receiving a second interrupt after the motor writing is completed; and
calculating at least one AF setting value to be used in a next frame for a second period of time in response to the second interrupt.

12. The frame-based auto-focus control method according to claim 11, wherein the motor reading and the motor writing are independently controlled to be performed substantially simultaneously based on the first interrupt.

13. The frame-based auto-focus control method according to claim 11, wherein the first interrupt includes a vertical synchronization (Vsync) signal of an image sensor, and the second interrupt includes a general-purpose input/output (GPIO) trigger signal.

14. The frame-based auto-focus control method according to claim 13, further comprising:
detecting, by a first hardware controller, the Vsync signal or the GPIO trigger signal and transmitting a motor reading command and a motor writing command via a Serial Peripheral Interface (SPI) bus; and
receiving, by a second hardware controller, the motor reading command and the motor writing command from the first hardware controller via the SPI bus and triggering the motor reading and the motor writing.

15. The frame-based auto-focus control method according to claim 14, wherein the second hardware controller includes an SPI controller, and the SPI controller is configured to perform the motor reading and the motor writing in parallel via the SPI bus.

16. The frame-based auto-focus control method according to claim 11, wherein the motor reading, the motor writing, and the calculation of the at least one AF setting value are performed within a time obtained by summing the first period of time and the second period of time for each frame.

17. The frame-based auto-focus control method according to claim 11, wherein the performing the motor reading and the motor writing comprises detecting a blank section while capturing frame data through an image sensor and controlling the motor reading and the motor writing to be performed during the blank section.

18. A frame-based auto-focus control device comprising:
a memory storing at least one program;
a hardware controller configured to manage a received interrupt; and
a processor executing the at least one program,
wherein the at least one program comprises:
a first instruction to perform motor reading and motor writing in parallel when a first interrupt is detected through the hardware controller; and
a second instruction to calculate at least one AF setting value for use in a next frame when a second interrupt is detected through the hardware controller after the motor writing is completed.

19. The frame-based auto-focus control device according to claim 18, wherein the first instruction is performed for a first period of time, the second instruction is performed for a second period of time, and the first instruction and the second instruction are performed within a time obtained by summing the first period of time and the second period of time for each frame.

20. The frame-based auto-focus control device according to claim 18, wherein the first interrupt includes a vertical synchronization (Vsync) signal of an image sensor, and the second interrupt includes a general-purpose input/output (GPIO) trigger signal.
